(19) United States
(12) Patent Application Publication
(10) Pub. No.: US 2005/0131843 A1
(43) Pub. Date: Jun. 16, 2005

(54) Method for the prepayment of customs duties

(75) Inventors: Ronald P. Sansone, Weston, CT (US); Erik D.N. Monsen, Shelton, CT (US)

Correspondence Address: Pitney Bowes Inc.;Intellectual Property And Technology Law Dept., 35 Waterview Drive, P.O. Box 3000, Shelton, CT, 06484, US

(73) Assignee: Pitney Bowes Incorporated, Stamford, CT (US)

(21) Appl. No.: 10/732,331

(22) Filed: Dec. 10, 2003

(51) Int. Cl. G06F 17/60

(52) U.S. Cl. 705/410

(57) ABSTRACT

A method for the prepayment by a shipper of customs duties and fees in a first country on shipments addressed for delivery in a second country that will be charged to the shippers' postage meter. For instance, if a package is mailed in the United Kingdom and delivered to a destination in the United States, the shipper's postage meter will place a Royal Mail postal indicia on the package for that portion of the postal delivery cost that is attributable to the United Kingdom post office and a United States Postal and Customs postal and customs indicia on the package for that portion of the delivery cost that is attributable to the United States Postal Service and United States Customs.

### CROSS REFERENCE TO RELATED APPLICATIONS

Reference is made to commonly assigned copending patent application Docket No. F-768 filed herewith entitled “Method For Indicating The Prepayment Of Customs Duties” in the names of Ronald P. Sansone and Erik D. N. Monsen.

### FIELD OF THE INVENTION

The invention relates generally to the field of mailing systems and, more particularly, to methods for the prepayment of customs duties.

### BACKGROUND OF THE INVENTION

Taxes and customs duties are compulsory payments by persons or organizations to the government. Even though governments receive payments from other sources such as publicly owned electric power facilities or the sale of timber from public lands, reparations, or from gifts, taxes are the most important source of government revenue. The revenue collected by the government is used to support itself and to provide public services.

Economic activity in a modern market economy is varied and complex, and governments have exercised great ingenuity in devising instrumentalities of taxation to match the complexities. As a result, there is no simplified classification of taxes that is considered satisfactory for all purposes.

One type of tax used by many governments is customs duties. A customs duty is the tax levied by a government for the importation of goods into a country and the use of the goods in the country. Customs duties have been used to protect local industries as well as to collect revenue. Countries have entered into tariff agreements in which the customs duties to be paid for the importation of goods from one country to another have been agreed upon. In order to collect the customs duties, shippers are required to complete time consuming detailed forms that are manually processed by customs agents.

When goods are shipped in a package from a first country to a second country by the post office of the first country, the package is transferred from the postal service of the first country to the second country at the border. A postal agent in the second country decides whether or not the package may continue its journey. If the second country postal agent determines that the package may continue its journey, the postal agent transmits the package to the recipient's local post office. Then the recipient's local post office notifies the recipient that recipient's package is available to be picked up at the post office. When the recipient arrives at the post office to pick up the package, recipient is informed how much duty recipient has to pay. The recipient pays the duty and receives the package. The foregoing is time consuming to the post office and to the recipient. If the second country postal agent determines that the package may not continue its journey, the postal agent delivers the package to the appropriate authorities. Thus, a problem of the prior art is that no provision is made for the prepayment in a first country of customs duties on shipments addressed for delivery in a second country.

### SUMMARY OF THE INVENTION

This invention overcomes the disadvantages of the prior art by utilizing a method for the prepayment by a shipper of customs duties and fees in a first country on shipments addressed for delivery in a second country that will be charged to the shippers' meter, i.e., postage meter. For instance, if a package is mailed in the United Kingdom and delivered to a destination in the United States, the shipper's postage meter will place a Royal Mail postal indicia on the package for that portion of the postal delivery cost that is attributable to the United Kingdom post office and a United States Postal and Customs postal and customs indicia on the package for that portion of the delivery cost that is attributable to the United States Postal Service and United States Customs. The United States postal and customs indicia and the Royal Mail postal indicia may or may not include the proportional amount of postage charged in the United States and Royal Mail postal indicium. The amount of postage paid may be totaled or written in an encrypted or coded form in the indicia in the vicinity of the indicia and/or in a radio frequency identification tag. It would be obvious to one skilled in the art that carriers other than posts, i.e., Federal Express®, Airborne®, DHL®, UPS®, etc., may use the meter disclosed hereunder for the payment of customs duties, terminal dues and fees.

An advantage of this invention is that it provides more accurate reporting and checking of the contents of mail for the collection of duties.

An additional advantage of this invention is that it decreases the amount of time it takes goods to be shipped from one country to another by reducing the amount of processing time required by Customs.

A further advantage of this invention is that it that it enables a shipper to automatically complete customs forms for the payment of duties.

An additional advantage of this invention is that it allows a postage meter to be used for the collection of customs duties and allows the sender to pay the duties.

### BRIEF DESCRIPTION OF THE DRAWINGS

FIG. 1A is a drawing of a package having a label with a postal meter indicia printed on the label and a radio frequency identification tag device embedded in the label that is affixed to the package;

FIG. 1B is a drawing of a package having a label with a Royal Mail postal meter indicia printed on the label, a United States Postage and Customs Duty indicia printed on the label and a radio frequency identification tag device embedded in the label that is affixed to the package;

FIG. 1C is a drawing of a package having a label with a Royal Mail postal meter indicia printed on the label, a United States Postage and Customs Duty indicia printed on the label and a two dimensional bar code printed on the label that is affixed to the package;

FIG. 2 is a block diagram of a dual meter that contains an electronic postage meter and a radio frequency identification reader/writer;

FIG. 3 is a drawing of a portion of a table of import duties for specified goods that United States customers ship from the United Kingdom to the United States;

FIG. 4 is a drawing of a statement showing the amount of import duties that are being prepaid for goods that are shipped from the United Kingdom to the United States; and

FIG. 5 is a drawing showing the payment of customs duties for goods that are shipped into the United States.

### DETAILED DESCRIPTION OF THE PREFERRED EMBODIMENT

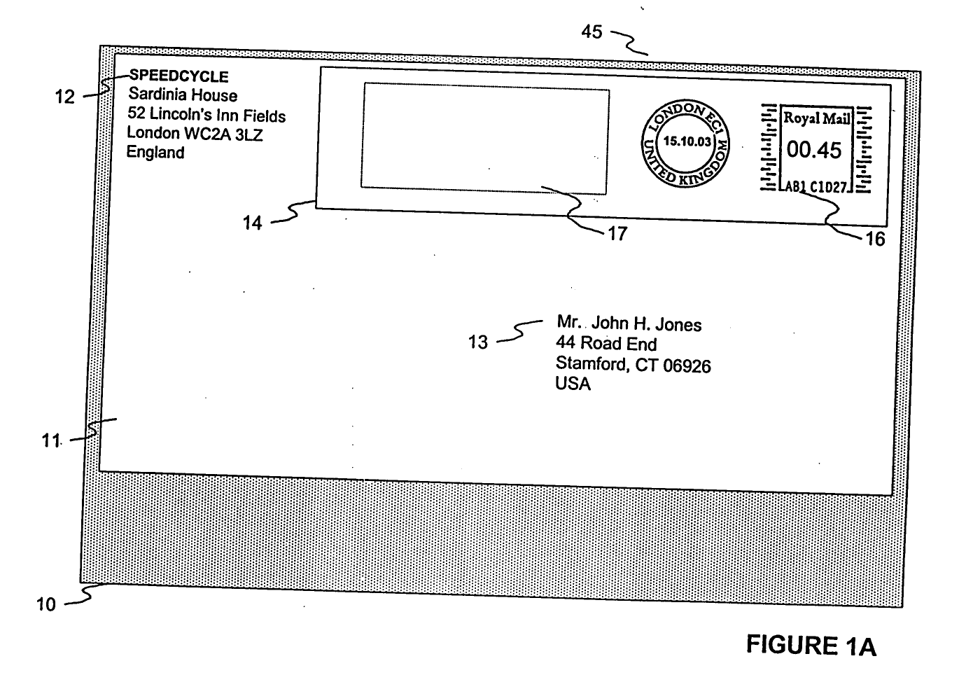

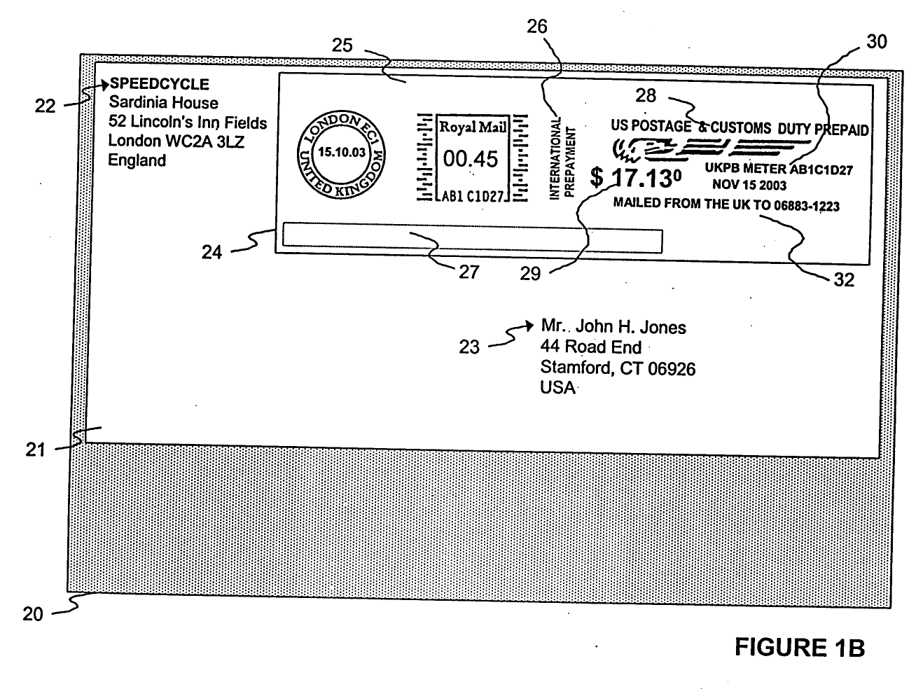

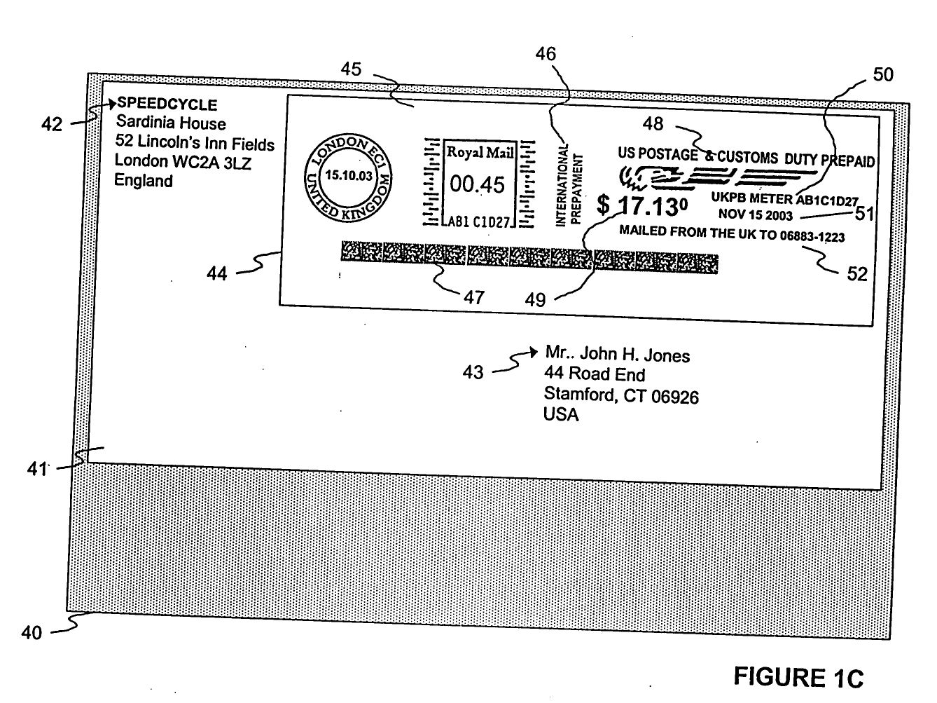

Referring now to the drawings in detail and more particularly to FIG. 1, the reference character 10 represents a package or flat that has a label 11 containing a sender address field 12, a recipient address field 13, and a label 14 that is affixed to package 10. Printed on label 14 are Royal Mail postal indicia 15 and an international mail destination 16. Label 14 also contains a flat radio frequency identification tag 17 that contains specified information. Postal indicia 15 may be a permit indicia, information-based indicia, printed indicia, penalty indicia, etc. Radio frequency identification (RFID) tag 17 may be the 4×6 RFID Smart Label Philips manufactured by RAFEC USA of 999 Oakmont Plaza Drive, Suite 200, Westmont, Ill. 60559. The information contained in tag 17 is the sender address field 12, recipient address field 13, a unique identification number for the package 10, amount of postage, amount of terminal dues, description of goods in package 10, weight of each of the goods in package 10, date goods were mailed, rates of duties for goods in package 10, customs duties that are due for the goods in package 10, fees, ECCN numbers for the goods in package 10, and type of special service to be performed by the carrier, etc. The expected recipient's delivery time may also be written into tag 17.

FIG. 1B is a drawing of a package having a label with a Royal Mail postal meter indicia printed on the label, a United States Postage and Customs Duty indicia printed on the label, and a radio frequency identification tag device embedded in the label that is affixed to the package. Package or flat 20 has a label 21 containing a sender address field 22, a recipient address field 23, and a label 24 that is affixed to package 20. Printed on label 24 are Royal Mail postal indicia 25 an international mail destination 26 and prepaid United States Postage and Customs duty indicia 28. Label 24 also contains a flat radio frequency identification tag 27 that contains specified information. Postal indicia 25 may be a permit indicia, information-based indicia, printed indicia, penalty indicia, etc. Postal indicia 28 contains the postage and customs duties 29 that are due for mailing the goods contained in package 21 from the United Kingdom to the United States. Postal indicia 28 also contains the serial number 30 of the postage meter that printed indicia 28, the date 31 that indicia 28 was printed and an indication 32 that package 20 was mailed from the United Kingdom to Zip Code 06883-1223. Radio frequency identification (RFID) tag 27 may be the 4×6 RFID Smart Label Philips manufactured by RAFEC USA of 999 Oakmont Plaza Drive, Suite 200, Westmont, Ill. 60559. The information contained in tag 27 is the sender address field 22, recipient address field 23, a unique identification number for the package 20, amount of postage, amount of terminal dues, description of goods in package 20, weight of each of the goods in package 20, date goods were mailed, rates of duties for goods in package 20, customs duties that are due for the goods in package 20, fees, ECCN numbers for the goods in package 20, and type of special service to be performed by the carrier etc. The expected recipient's delivery time may also be written into tag 27.

FIG. 1C is a drawing of a package having a label with a Royal Mail postal meter indicia printed on the label, a United States Postage and Customs Duty indicia printed on the label, and a two-dimensional bar code printed on the label that is affixed to the package. Package or flat 40 has a label 41 containing a sender address field 42, a recipient address field 43, and a label 44 that is affixed to package 40. Printed on label 44 are Royal Mail postal indicia 45, an international mail destination 46, and prepaid United States Postage and Customs duty indicia 48. Label 44 also contains a two-dimensional bar code 47 that contains specified information. Postal indicia 45 may be a permit indicia, information-based indicia, printed indicia, penalty indicia, etc. Postal indicia 48 contains the postage and customs duties 49 that are due for mailing the goods contained in package 41 from the United Kingdom to the United States. Postal indicia 48 also contains the serial number 50 of the postage meter that printed indicia 48, the date 51 that indicia 48 was printed, and an indication 52 that package 40 was mailed from the United Kingdom to Zip Code 06883-1223. Two-dimensional bar code 47 may be encrypted. The information contained in bar code 47 is the sender address field 42, recipient address field 43, a unique identification number for the package 40, amount of postage, amount of terminal dues, description of goods in package 40, weight of each of the goods in package 40, date goods were mailed, rates of duties for goods in package 40, customs duties that are due for the goods in package 40, fees, ECCN numbers for the goods in package 40, and type of special service to be performed by the carrier etc. The expected recipient's delivery time may also be bar code 47.

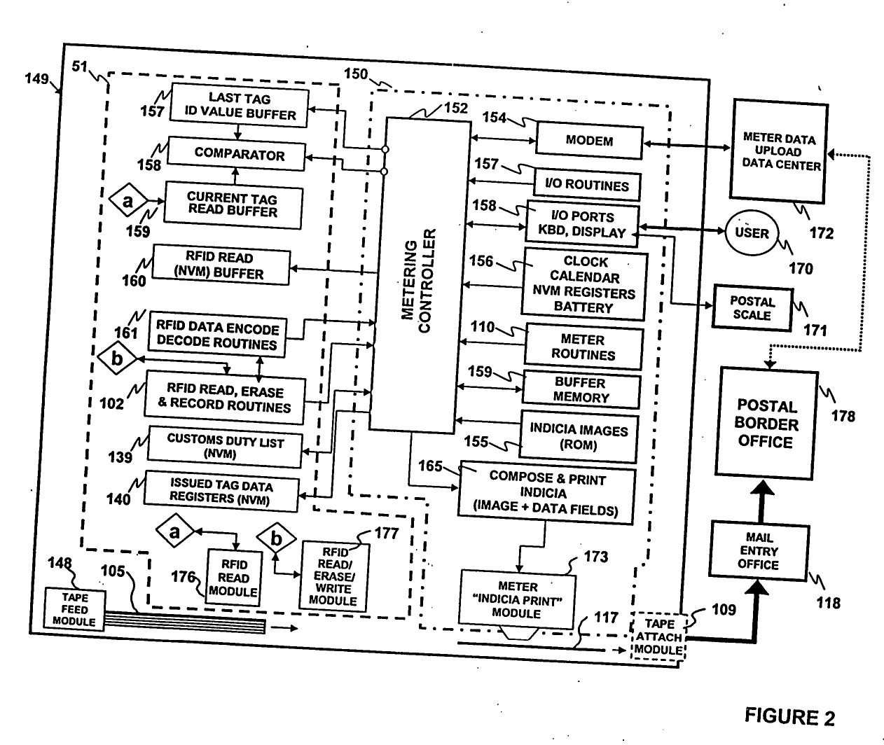

FIG. 2 is a block diagram of a dual meter 149 that contains electronic postage meter 150, a radio frequency identification reader/writer 151, tape feed module 148 and a tape attach module 109. Postage meter 150 may be the B700 Post Perfect postage meter manufactured by Pitney Bowes Inc. of Stamford, Conn.

Metering controller 152 functions as a meter controller for postage meter 150 and a controller for radio frequency identification reader/writer 151. Controller 152 is coupled to last tag buffer 157, comparator 158, current read tag buffer 159, radio frequency identification read non-volatile memory buffer 160, radio frequency identification encode/decode routines 161, radio frequency identification read, erase and record routine 102, customs duty list non-volatile memory 139, and issued tag data registers non-volatile memory 140. Comparator 158 is coupled to last tag identification buffer 157 and current tag read buffer 159. Buffer 159 is coupled to radio frequency identification read module 176, and radio frequency identification encode/decode routines 161 is coupled to radio frequency identification read, erase and record routine 102. Routines 102 are also coupled to radio frequency identification read/erase/record module 177.

Electronic meter 150 includes meter routines 153, modem 154, indicia image routines 155, clock calendar non-volatile memory registers and battery 156, I/O routines 107, I/O ports keyboard and display 108, buffer memory 110 and compose and print indicia image and data fields 165. Controller 152 is coupled to modem 154, I/O routines 107, meter routines 153, I/O port keyboard and display 108. Compose and print indicia 165 is coupled to meter indicia print module 173.

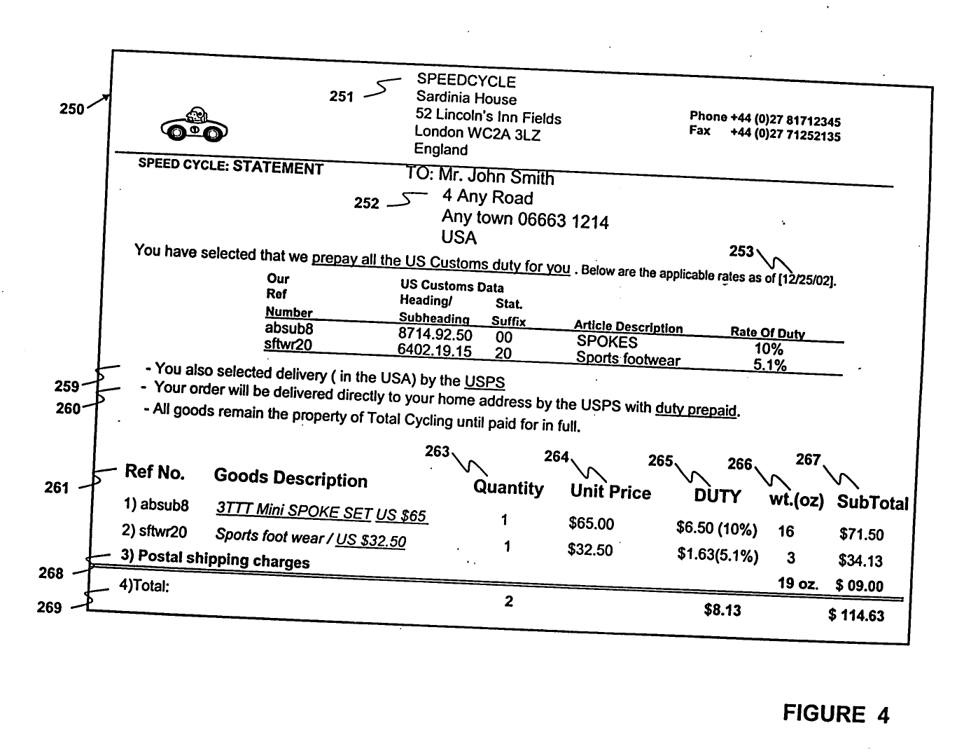

Meter 150 begins to function when a user 170 sets the postage dollar amount by weighing package 10, 20, or 40 on scale 171 and enters the information which is described in the description of FIG. 4 into I/O ports, keyboard and display 108 of meter 150. Alternatively, the information described in the description of FIG. 4 may be supplied by customs duty list 139. The weight and amount of postage and amount of customs duties and/or fees that are due for package 10, 20, or 40 is displayed by display 108. Controller 152 will compose an image of indicia 15 (FIG. 1A), indicia 25 and 28 (FIG. 1B), indicia 45 and 48 (FIG. 1C) using the fixed graphic indicia images from indicia images ROM 155 and compose and print indicia images and data field 165. The above image will be stored in buffer memory 110. Buffer memory 110 will provide the above image to meter controller 152.

Meter routines 153 will handle the accounting functions of meter 150. Routines 153 are not being described, because one skilled in the art is aware of their operation and function. Clock calendar non-volatile memory registers and battery 156 will transmit the date and time to controller 152.

Modem 154 may communicate with meter data upload data center 172 during a refill of postage meter 150 by exchanging funds. User 170 of postage/customs dual meter 149 communicates with I/O ports keyboard display 108. Postal scale 171 is coupled to I/O ports keyboard display 108 and is used to determine the weight of package 10, 20, 40. Postal border office 178 is coupled to meter data upload data center 172. Mail entry office 118 receives packages that have been processed by dual meter 149. Packages flow from office 118 to postal border office 178. Meter data upload data center 172 is coupled to data center 178, and mail entry office 118. I/O routines 107 will control the interfacing of various components so that the information in customs duty list 139 will be sent to meter data upload center 172 soon after the type of goods in packages 10, 20, or 40 are entered into I/O ports, keyboard display 108 and written in tag 17 (FIG. 1A), 27 (FIG. 1B), 47 (FIG. 1C). The images and data fields of indicia 15, 25, 28,45, and 48 will be transmitted from compose and print indicia 165 to meter indicia print module 173.

Radio frequency identification tag read/writer 151 will begin to function when controller 152 enters the last tag identification value in buffer 157 and current tag read buffer 159 receives the information that module 176 read from the tag 15 portion of label 17 (FIG. 1). Comparator 158 will compare the last tag identification value stored in buffer 157 with the value read by module 176. If comparator 158 determines that the above values are the same, then tag 15 is being used a second time for adjustment purposes, i.e., corrected information is going to be recorded into tag 17, 27 47.

Radio frequency identification read buffer 160 is a nonvolatile memory that is used to store the information that is read from tag 17, 27, 47 in case of a power failure, and radio frequency identification encode/decode routines 161 are used to decode the information read from tag 17, 27, 47 and encode data that is going to be recorded in tag 17, 27 47. Radio frequency identification read, erase and record routine 102 are used to read, erase and record information into tag 17, 27 47.

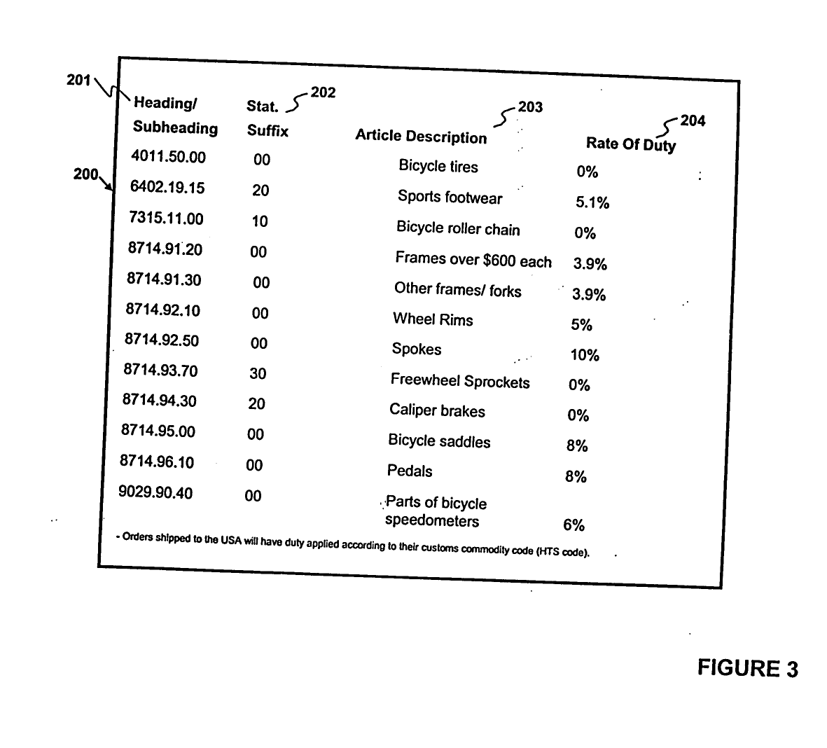

Customs duty list 139 contains a list of import duties for goods that are imported into the United States. List 139 indicates the duties for goods that may be placed in package 10, 20, 40. List 139 will be more fully described in the description of FIG. 3. Issued tag data registers nonvolatile memory 140 stores the information recorded in tag 17, 27, 47, which is uploaded to data center 178 via data center 172.

Tape and feed module 148 contains a stack of labels 105 that include tags 17, 27, or 47. Label 14 (FIG. 1A), 24 (FIG. 1B), 44 (FIG. 1C) is transported past radio frequency identification read module 176. Module 176 is positioned in a manner that it will be able to read the information recorded in tags 17, 27, or 47 so that module 176 will be able to determine whether or not information has been previously recorded into tag 17, 27, or 47. Then label 14, 24, 44 will be transported to module 177 where information will be read, erased and recorded on tag 17, 27, 47. Then label 14, 24, 44 will be transported to paper tape attach module 109. After information is recorded on tag 17, label 14, or tag 27 label 24 or tag 47 label 44 will be positioned adjacent module 173 so that indicia may be printed on the respective labels. Module 109 will affix label 14 to package 10 (FIG. 1A); label 24 to package 20 (FIG. 1B); label 44 to package 40 (FIG. 1C).

FIG. 3 is a drawing of a portion of a table 200 of import duties for specified goods that United States customers ship from the United Kingdom to the United States. The information listed in table 200 is stored in customs duty list 139 (FIG. 2) and displayed on I/O ports keyboard, display 108 (FIG. 2). Column 201 list the United States Customs heading/subheading for particular goods and column 202 indicates the Statute suffix for particular goods. Column 203 lists a description of the goods, and column 204 lists the rate of duty for these goods. It would be obvious to one skilled in the art that list 200 may include other relevant customs information and that other customs information will be added when a customs mandated update is required.

FIG. 4 is a drawing of a statement showing the amount of import duties that are being prepaid for goods that are shipped from the United Kingdom to the United States. Seller 251 prepared statement 250 for buyer 252. Statement 250 has an indication 253 that the buyer has elected to have the seller prepay all the United States Customs duties for the buyer and that the applicable customs rates as of Dec. 25, 2002. Column 254 lists the seller's reference number for goods that are being ordered, and column 255 lists the United States Customs heading/subheading for particular goods. Column 256 indicates the Statute suffix for particular goods. Column 257 indicates the description of the goods and column 258 indicates the rate of duty for the goods.

Statement 259 indicates that the buyer has selected delivery in The United States by the United States Postal Service, and statement 260 indicates that the order will be delivered to the buyer's home address in the United States by the United States Postal Service. Column 261 lists the seller's reference number for goods that are being ordered and column 262 lists a description of the goods. Column 263 lists the quantity of goods ordered, and column 264 lists the unit price of the goods ordered. Column 265 indicates the customs duty for the goods ordered and column 266 indicates the weight in ounces of the goods ordered. Column 267 indicates the subtotal of the goods ordered. Line 268 indicates the postal shipping charges including terminal dues for the goods ordered and line 269 indicates the respective totals for columns 263, 265 and 267.

The information contained in statement 250 is stored in buffer memory 110 (FIG. 2) and displayed on I/O ports keyboard, display 108 (FIG. 2).

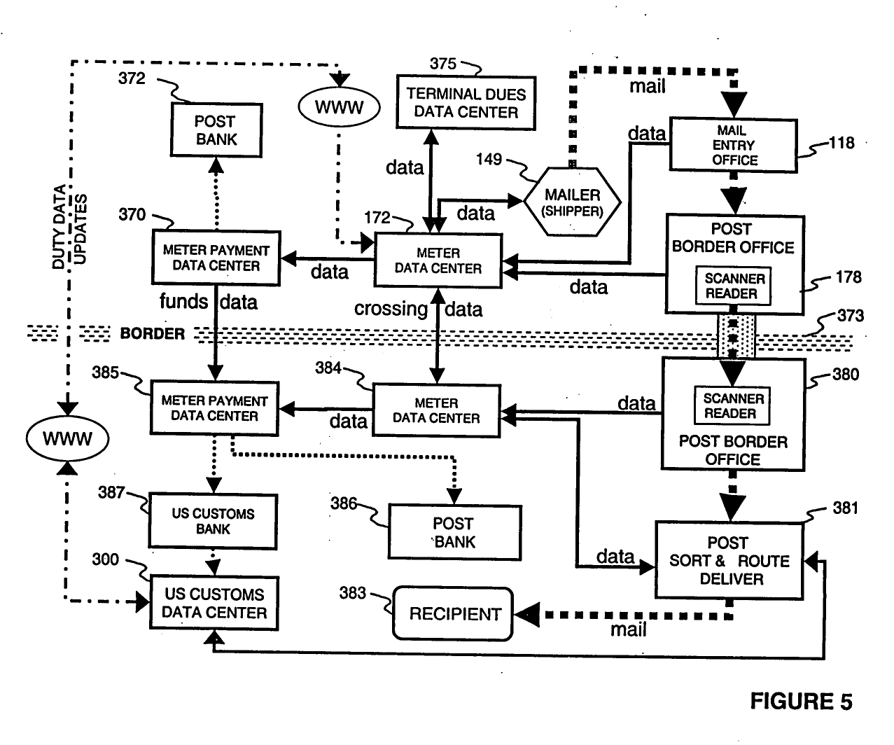

FIG. 5 is a drawing showing the payment of customs duties for goods that are shipped into the United States. When package 10 is mailed in the United Kingdom and delivered to a destination in the United States, the mailer's dual postage/customs duty meter 149 will have previously placed a United Kingdom Postal Indicia 15 and a RFID tag 17 (FIG. 1A) for the delivery cost for delivering package 10 to the recipient in the United States and paying the United States Postal Service (USPS) for the United States postage and the US customs for the customs duties that are due for the goods contained in package 10. The foregoing data will be transferred from meter 149 to United Kingdom Meter Data Center 172. Then the data will be transmitted to United Kingdom Meter payment data center 370. Data center 370 will then deposit the monies attributable to indicia 15 in Royal Mail Bank 372. Thus, if the goods listed in statement 250 were placed in package 10, indicia 15 would indicate an amount of 0.45 pounds for postage.

When package 20 is mailed in the United Kingdom and delivered to a destination in the United States, the mailer's dual postage/customs duty meter 149 will have previously placed a United Kingdom Postal Indicia 25, a prepaid United States Postage and Customs duty indicia 28 and a RFID tag 27 (FIG. 1B) for the delivery cost for delivering package 20 to the recipient in the United States and paying the USPS for the United States postage and the US customs for the customs duties that are due for the goods contained in package 20. The foregoing data will be transferred from meter 149 to United Kingdom Meter Data Center 172. Then the data will be transmitted to United Kingdom Meter payment data center 370. Data center 370 will then deposit the monies attributable to indicia 25 in Royal Mail Bank 372. Thus, if the goods listed in statement 250 were placed in package 20, indicia 25 would indicate an amount of 0.45 pounds for postage and prepaid United States Postage and Customs duty indicia 28 would indicate an amount of $17.13.

When package 40 is mailed in the United Kingdom and delivered to a destination in the United States, the mailer's dual postage/customs duty meter 149 will have previously placed a United Kingdom Postal Indicia 45, a prepaid United States Postage and Customs duty indicia 48, and a two-dimensional bar code 47 (FIG. 1C) for the delivery cost for delivering package 40 to the recipient in the United States and paying the USPS for the United States postage and the US customs for the customs duties that are due for the goods contained in package 40. The foregoing data will be transferred from meter 149 to United Kingdom Meter Data Center 172. Then the data will be transmitted to United Kingdom Meter payment data center 370. Data center 370 will then deposit the monies attributable to indicia 45 in Royal Mail Bank 372. Thus if the goods listed in statement 250 were placed in package 40, indicia 45 would indicate an amount of 0.45 pounds and prepaid United States Postage and Customs duty indicia 48 would indicate an amount of $17.13.

United Kingdom meter data center 172 will maintain the accuracy of the United States customs duties and fees by accessing United States customs data center 300. Data Center 172 will maintain the accuracy of the terminal dues by accessing terminal dues data center 375. After package 20 (FIG. 1B) is posted it will be sorted, routed and transferred by the Royal Mail in mail entry office 118, and the delivery status of package 20 will be sent to United Kingdom meter data center 172. Scanners at postal border office 178 will read indicia 25, indicia 28 and RFID tag 27 including the unique identification number contained within tag 27 so that the amount of postage and amount of customs duties will be interpreted and forwarded to United Kingdom Meter Data Center 172.

At the same time, the United Kingdom Meter Data Center 172 notifies the USPS meter data center 384 that package 20 is departing. As package 20 approaches the United States border 373, scanners at postal entry border office 380 will read indicia 25, indicia 28 and RFID tag 27 including the unique identification number contained within tag 27. The foregoing read data will be interpreted and sent to United States Postal Service meter data center 384, which transmits the data to USPS meter payment data center 385 and United Kingdom Meter Data Center 172.

Package 20 will be processed by postal sort route and deliver process 381 and delivered to recipient 383. Process 381 will inform data center 384 and U.S. customs data center 300 that package 20 has been processed. Then data center 384 will inform United States Meter Payment Data Center 385 and United Kingdom Meter Data Center 172 that package 20 has been processed. United Kingdom Meter Data Center 172 will inform United Kingdom Meter Payment Data Center 370 that package 20 has been processed. Data center 370 will transfer the money for United States postage, United States customs, duties and United States fees that have been charged to meter 149 for the affixing of indicia 28 and RFID tag 27 to package 20 to United States Meter Payment Data Center 385. Data center 385 will transmit the postage monies to USPS bank 386 and the monies for the United States customs, duties and the United States fees to United States Customs bank 387.

The above specification describes a new and improved method for indicating the prepayment of customs duties. It is realized that the above description may indicate to those skilled in the art additional ways in which the principles of this invention may be used without departing from the spirit. Therefore, it is intended that this invention be limited only by the scope of the appended claims.

1. A method for pre paying customs duties comprising the steps of:
A. charging a sender's meter for delivering a package that is being deposited with a first carrier located in a first country to be delivered by a second carrier located in a second country to a recipient located in the second country; and
B. paying customs with funds charged to the sender's meter for the duties owed for having the package enter the second country.

2. The method claimed in claim 1, further including the step of:
paying the first carrier with funds charged to the senders meter for delivering the package to the second carrier.

3. The method claimed in claim 1, further including the step of:
paying the second carrier with funds charged to the sender's meter for delivering the package to the recipient.

4. A method for pr paying customs duties to a second carrier located in a second country for a package that has been deposited and paid for by a sender to a first carrier located in a first country to be delivered by the second carrier located in the second country to a recipient located in the second country, comprising the steps of:
charging a sender's meter for a package that is being deposited with a first carrier;
transmitting the funds charged to the meter attributable to the first and second carriers to a meter data center;
transmitting from the first meter data center to a first carrier meter payment center the funds attributable to the first and second carriers; and
transmitting from the first carrier meter payment data center to the second carrier meter payment data center the funds attributable to the second carrier.

5. The method claimed in claim 4, wherein: the funds attributable to the first country carrier are determined by the following step:
determining the postage for the package.

6. The method claimed in claim 4, wherein the funds attributable to the second country carrier are determined by the following steps:
determining the customs duties required for the goods in the package.

7. The method claimed in claim 6, further including the step of determining the fees required to deliver the package and the cost associated therewith.

8. The method claimed in claim 6, further including the step of determining the postage required to deliver the package to the second country.

9. The method claimed in claim 4, further including the steps of:
scanning the package when the package leaves the first country; and
scanning the package when the package arrives in the second country, whereby funds are transferred from the first meter payment data center to the second country meter payment data center when the package is scanned in the second country.

10. The method claimed in claim 4, further including the step of:
placing a unique identification code on the package to uniquely identify the package.

11. The method claimed in claim 10, wherein the unique identification code is contained in a radio frequency identification tag.

12. The method claimed in claim 10, further including the step of:
recording information regarding the sender of the package in the tag.

13. The method claimed in claim 10, further including the step of:
recording information regarding a recipient of the package in the tag.

14. The method claimed in claim 10, further including the step of:
recording information regarding the goods in the package in the tag.

15. The method claimed in claim 10, further including the step of:
recording information regarding the rates of duties of goods in the package in the tag.

16. The method claimed in claim 10, further including the step of:
recording information regarding the customs duties that were prepaid for the goods in the package in the tag.

17. The method claimed in claim 10, further including the step of:
recording information regarding the ECCN of the goods in the package in the tag.

18. The method claimed in claim 10, further including the step of:
recording information regarding terminal dues in the tag.

19. The method claimed in claim 10, further including the step of:
transmitting funds attributable to the first carrier from the first carrier meter payment center to a first carrier bank.

20. The method claimed in claim 10, wherein the unique identification code is contained in a bar code.

21. The method claimed in claim 4, further including the step of:
transmitting funds from the second carrier meter payment center to the second carrier bank.

22. The method claimed in claim 4, further including the step of:
transmitting funds from the second carrier meter payment center to the second carrier bank after entry of the package in the second country.
